(19) United States
(12) Patent Application Publication
(10) Pub. No.: US 2012/0021282 A1
(43) Pub. Date: Jan. 26, 2012

(54) POSITIVE ELECTRODE FOR NONAQUEOUS ELECTROLYTE SECONDARY BATTERY, NONAQUEOUS ELECTROLYTE SECONDARY BATTERY, AND METHOD FOR PRODUCING THE SAME

(75) Inventors: Daisuke KATOU, Kobe-city (JP); Takanobu CHIGA, Kobe-city (JP); Naoki IMACHI, Kobe-city (JP)

(73) Assignees: MITSUBISHI CHEMICAL CORPORATION, Tokyo (JP); SANYO ELECTRIC CO., LTD., Osaka (JP)

(21) Appl. No.: 13/188,131

(22) Filed: Jul. 21, 2011

(30) Foreign Application Priority Data
Jul. 21, 2010 (JP) 2010-164101

(51) Int. Cl. H01M 4/13; B05D 5/12

(52) U.S. Cl. 429/211; 427/77

(57) ABSTRACT

A positive electrode for a nonaqueous electrolyte secondary battery, which has excellent nonaqueous electrolyte permeability, a nonaqueous electrolyte secondary battery including the positive electrode, and a method for producing the same. A positive electrode for a nonaqueous electrolyte secondary battery includes a positive electrode current collector, and a positive electrode active material layer. The positive electrode active material layer is formed on the positive electrode current collector and contains a positive electrode active material, a binder, and an acid anhydride.

### CROSS REFERENCE TO RELATED APPLICATIONS

The present invention claims priority to Japanese Patent Application No. 2010-164101 filed in the Japan Patent Office on Jul. 21, 2010, the entire contents of which are incorporated herein by reference.

### BACKGROUND OF THE INVENTION

1. Field of the Invention

The present invention relates to a positive electrode for a nonaqueous electrolyte secondary battery, a nonaqueous electrolyte secondary battery including the positive electrode, and a method for producing the nonaqueous electrolyte secondary battery.

2. Description of Related Art

In recent years, reduction in size and weight of mobile information devices such as mobile phones, notebook-size personal computers, PDA, etc. has been rapidly developed. Accordingly, nonaqueous electrolyte secondary batteries used as drive power supplies for the mobile information devices are required to have higher capacity. In addition, application of nonaqueous secondary batteries to uses such as HEV (Hybrid Electric Vehicles) and electric tools, which are required to have high output, has been advanced. Therefore, the demand for nonaqueous electrolyte secondary batteries to have higher output has been increased.

In order to achieve higher capacity and higher output of nonaqueous electrolyte secondary batteries, it is necessary to increase the thickness and density of electrode active material layers. However, when the thickness and density of active material layers are increased, nonaqueous electrolyte permeability in the active material layers deteriorates, thereby increasing the time required for impregnating electrode bodies with the nonaqueous electrolytes. This results in the problem of decreasing the productivity of nonaqueous electrolyte secondary batteries.

### BRIEF SUMMARY OF THE INVENTION

In consideration of the above-mentioned problem, for example, Japanese Published Unexamined Patent Application No. 2001-35484 (Patent Document 1) discloses that nonaqueous electrolyte permeability in an active material layer is improved by forming a slit-shaped gap in the active material layer so as to reach an end surface thereof.

However, when a gap is provided in an active material layer as in Patent Document 1, the volume occupied by the active material layer is decreased, thereby causing disadvantage in increasing the capacity of a battery. In addition, the step of forming the gap in the active material layer is required, resulting in the problem of complicating the process for manufacturing a nonaqueous electrolyte secondary battery.

An object of the present invention is to provide a positive electrode for a nonaqueous electrolyte secondary battery, which is excellent in nonaqueous electrolyte permeability, a nonaqueous electrolyte secondary battery including the positive electrode, and a method for producing the nonaqueous electrolyte secondary battery.

A positive electrode for a nonaqueous electrolyte secondary battery according to the present invention includes a positive electrode current collector and a positive electrode active material layer. The positive electrode active material layer is formed on the positive electrode current collector. The positive electrode active material layer contains a positive electrode active material, a binder, and an acid anhydride.

In the present invention, the positive electrode active material layer contains an acid anhydride and nonaqueous electrolyte permeability into the positive electrode active material layer is improved. In addition, while a groove need not be formed in the positive electrode active material layer, the volume of the positive electrode active material layer can be increased. Therefore, the capacity of a battery can be increased. Further, complication of the production process can be suppressed.

Reasons why nonaqueous electrolyte permeability is improved by adding the acid anhydride to the positive electrode active material layer are as follows.

One reason is that since the positive electrode active material layer contains the acid anhydride having high affinity with a nonaqueous electrolyte, affinity of the nonaqueous electrolyte with the positive electrode active material layer is improved. Another reason is that the acid anhydride is dissolved in the nonaqueous electrolyte, and thus when the positive electrode active material layer contacts the nonaqueous electrolyte, the acid anhydride is eluted from the positive electrode active material layer, producing holes in the positive electrode active material layer. Consequently, the nonaqueous electrolyte is rapidly supplied to the inside of the positive electrode active material layer via the holes.

In addition, as described above, in the positive electrode for a nonaqueous electrolyte secondary battery according to the present invention, the acid anhydride is eluted from the positive electrode active material layer due to contact with the nonaqueous electrolyte, producing holes. Therefore, the area of contact between the nonaqueous electrolyte and the positive electrode active material can be increased, and the battery capacity can be increased. In addition, the positive electrode active material layer has high flexibility in the nonaqueous electrolyte. Therefore, the positive electrode active material layer is little separated from the positive electrode current collector or broken.

In the present invention, the type of the acid anhydride is not particularly limited. Preferably, the positive electrode active material layer preferably contains, as the acid anhydride, at least one of succinic anhydride, maleic anhydride, and phthalic anhydride.

The content of the acid anhydride relative to the positive electrode active material is not particularly limited. The content is preferably within the range of 0.01% by mass to 5% by mass, more preferably within the range of 0.1% by mass to 2% by mass. When the content of the acid anhydride is excessively low, nonaqueous electrolyte permeability may not be sufficiently improved. On the other hand, when the content of the acid anhydride is excessively high, adhesion between the positive electrode active material layer and the positive electrode current collector may be decreased.

In the present invention, the types of the positive electrode active material and the binder are not particularly limited.

Preferred examples of the positive electrode active material include lithium transition metal composite oxides having a layered structure, a spinel structure, or an olivine structure. Lithium transition metal composite oxides having a layered structure with a high energy density are preferably used. Examples of the lithium transition metal composite oxides having a layered structure include lithium-nickel composite oxides, lithium-nickel-cobalt composite oxides, lithium-nickel-cobalt-aluminum composite oxides, lithium-nickel-cobalt-manganese composite oxides, lithium-cobalt composite oxides, and the like. From the viewpoint of decreasing the amount of expensive cobalt used, lithium transition metal composite oxides having a nickel ratio of 50 mol % or more of transition metals contained in the positive electrode active material are preferred. From the viewpoint of stability of the crystal structure, lithium transition metal composite oxides containing lithium, nickel, cobalt, and aluminum are more preferred.

Preferred examples of the binder include PVDF (polyvinylidene fluoride) and modified products of PVDF, fluorocarbon resins having a vinylidene fluoride unit, and the like.

In addition, in the present invention, the positive electrode active material layer may further contain a conductive agent. Preferred examples of the conductive agent include carbon black such as acetylene black (AB), KETJENBLACK, and the like; and amorphous carbon such as needle coke and the like.

In the present invention, the positive electrode current collector is not particularly limited. The positive electrode current collector can be made of, for example, a metal foil such as an aluminum foil, or an alloy foil.

The positive electrode for a nonaqueous electrolyte secondary battery according to the present invention can be formed by applying a positive electrode slurry containing the positive electrode active material, the binder, the acid anhydride, and a solvent on the positive electrode current collector, and then drying the positive electrode slurry. If required, the positive electrode slurry may be rolled after drying. Preferred examples of the solvent used for preparing the positive electrode slurry include N-methyl-2-pyrrolidone (NMP) and the like.

A nonaqueous electrolyte secondary battery according to the present invention includes an electrode body including the above-described positive electrode for a nonaqueous electrolyte secondary battery according to the present invention, a negative electrode, and a separator disposed between the positive electrode and the negative electrode, and a nonaqueous electrolyte impregnated in the electrode body.

A method for producing a nonaqueous electrolyte secondary battery according to the present invention relates to a method for producing the above-described nonaqueous electrolyte secondary battery according to the present invention. The method for producing a nonaqueous electrolyte secondary battery according to the present invention includes a step of forming an electrode body, and a step of impregnating the electrode body with a nonaqueous electrolyte.

As described above, the positive electrode for a nonaqueous electrolyte secondary battery according to the present invention is excellent in nonaqueous electrolyte permeability. According to the present invention, a nonaqueous electrolyte secondary battery can be produced within a short time without using a complicated production process.

In the present invention, the negative electrode and the separator are not particularly limited.

The negative electrode generally includes a negative electrode current collector and a negative electrode active material layer. The negative electrode current collector can be made of, for example, a metal foil such as a copper foil, or an alloy foil.

The negative electrode active material layer generally contains a negative electrode active material, a binder, and a conductive agent. The negative electrode active material is not particularly limited as long as it is a material which can occlude and discharge lithium. Examples of the negative electrode active material include carbon materials such as graphite, coke, and the like; metal oxides such as tin oxide and the like; metals such as silicon, tin, and the like, which can occlude lithium by alloying with lithium; metallic lithium; and the like. Among these materials, graphite-based carbon materials having excellent reversibility and causing little change in volume with occlusion and discharge of lithium are preferably used.

Examples of the binder added to the negative electrode active material layer include latex-type resins, polyvinylidene fluoride, and the like.

In the present invention, the negative electrode current collector is not particularly limited as long as it has conductivity. The negative electrode current collector can be made of, for example, a conductive metal foil. Examples of the conductive metal foil include foils of metals such as copper, nickel, iron, titanium, cobalt, manganese, tin, silicon, chromium, zirconium, and the like, and alloys each containing at least one of these metals. Among these, conductive metal foils containing a metal element which easily diffuses in active material particles are preferred. The negative electrode current collector is preferably made of a copper thin film or a foil containing a copper alloy.

Also, a solvent used in the nonaqueous electrolyte is not particularly limited. Examples of the solvent used in the nonaqueous electrolyte include cyclic carbonates such as ethylene carbonate, propylene carbonate, butylene carbonate, fluoroethylene carbonate, vinylene carbonate, vinylethylene carbonate, and the like; chain carbonates such as dimethyl carbonate, methylethyl carbonate, diethyl carbonate, and the like; mixed solvents of the cyclic carbonates and the chain carbonates; and the like. The mixed solvents of the cyclic carbonates and the chain carbonates are preferably used, and the mixed solvents of the cyclic carbonates and the chain carbonates at a volume ratio (cyclic carbonate:chain carbonate) of 1:9 to 5:5 are more preferably used.

Also, a solute used in the nonaqueous electrolyte is not particularly limited. Examples of the solute used in the nonaqueous electrolyte include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, and LiClO₄, and mixtures thereof. In addition, a gel-like polymer electrolyte including a polymer electrolyte, such as polyethylene oxide or polyacrylonitrile, impregnated with an electrolyte, or an inorganic solid electrolyte such as LiI, Li₃N, or the like, may be used as the electrolyte.

According to the present invention, a positive electrode for a nonaqueous electrolyte secondary battery, which has excellent nonaqueous electrolyte permeability, a nonaqueous electrolyte secondary battery including the positive electrode, and a method for producing the same can be provided.

### BRIEF DESCRIPTION OF THE SEVERAL VIEWS OF THE DRAWINGS

FIG. 1 is a schematic sectional view showing a nonaqueous electrolyte secondary battery formed in Example 1.

FIG. 2 is a partially enlarged schematic sectional view showing a positive electrode formed in Example 1.

### DETAILED DESCRIPTION OF THE INVENTION

The present invention is described in further detail below on the basis of examples, but the present invention is not limited to these examples, and appropriate modifications can be made without changing the gist of the invention.

### Example 1

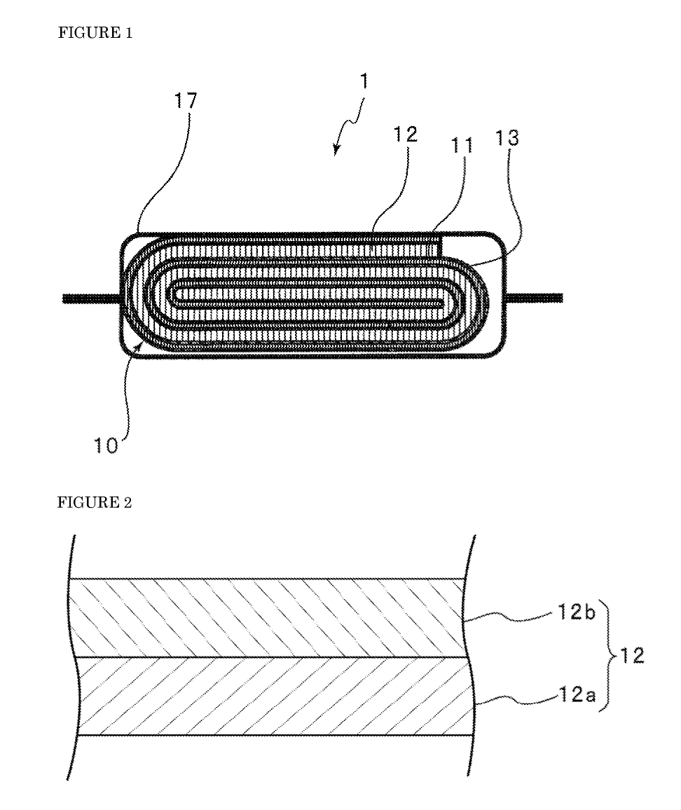

In this example, a nonaqueous electrolyte secondary battery 1 shown in FIG. 1 was formed in a manner described below.

### Formation of Positive Electrode 12

LiCoO₂ used as a positive electrode active material, AB (acetylene black) as a conductive agent, and PVDF as a binder were kneaded together with NMP as a solvent. Then, a NMP solution in which succinic anhydride was dissolved was further added, and the resultant mixture was stirred to prepare a positive electrode slurry. In preparing the positive electrode slurry, the mass ratio (LiCoO₂:AB:PVDF:succinic anhydride) between LiCoO₂, AB, PVDF, and succinic anhydride was adjusted to 94:2.5:2.5:1. Therefore, in the example, the content of succinic anhydride was 0.1% by mass relative to the positive electrode active material.

Next, the prepared slurry was applied to both surfaces of an aluminum foil 12a so as to have 304 mg/10 cm², dried, and then rolled to form a positive electrode active material layer 12b. The packing density of the positive electrode 12 was 3.8 g/cc.

### Formation of Negative Electrode 11

Graphite used as a negative electrode active material, styrene-butadiene rubber (SBR) as a binder, and carboxymethyl cellulose (CMC) as a thickener were kneaded in an aqueous solution to prepare a negative electrode slurry. The mass ratio (graphite:styrene-butadiene rubber:CMC) between graphite, SBR, and CMC in the negative electrode slurry was 98:1:1.

Next, the prepared negative electrode slurry was applied to both surfaces of a negative electrode current collector composed of a copper foil, dried, and then rolled to form the negative electrode 11.

### Preparation of Nonaqueous Electrolyte

Ethylene carbonate (EC) and diethyl carbonate (DEC) were mixed at a volume ratio (EC:DEC) of 3:7, and LiPF₆ was further added to the resultant mixture at 1.0 mol/l to prepare a nonaqueous electrolyte.

### Assembly of Nonaqueous Electrolyte Secondary Battery

A lead terminal was attached to each of the positive electrode and the negative electrode, and the positive electrode and the negative electrode were coiled with a separator 13 provided therebetween, and pressed to a flat shape, forming an electrode body 10. The resultant electrode body 10 was inserted into an aluminum laminate used as a battery outer casing 17, and then the nonaqueous electrolyte was injected, thereby forming the nonaqueous electrolyte secondary battery 1. In addition, the battery was designed so that the charge cutoff voltage was 4.4 V, and the design capacity was 750 mAh.

### Example 2

A nonaqueous electrolyte secondary battery was formed by the same method as in Example 1 except that the content of succinic anhydride relative to the positive electrode active material was 0.5% by mass.

### Example 3

A nonaqueous electrolyte secondary battery was formed by the same method as in Example 1 except that the content of succinic anhydride relative to the positive electrode active material was 1.0% by mass.

### Example 4

A nonaqueous electrolyte secondary battery was formed by the same method as in Example 1 except that the content of succinic anhydride relative to the positive electrode active material was 2.0% by mass.

### Example 5

A nonaqueous electrolyte secondary battery was formed by the same method as in Example 2 except that maleic anhydride was added to the positive electrode active material layer in place of succinic anhydride.

### Example 6

A nonaqueous electrolyte secondary battery was formed by the same method as in Example 2 except that phthalic anhydride was added to the positive electrode active material layer in place of succinic anhydride.

### Comparative Example 1

A nonaqueous electrolyte secondary battery was formed by the same method as in Example 1 except that in order to form a positive electrode, a positive electrode slurry was prepared so that the mass ratio (LiCoO₂:AB:PVDF) between LiCoO₂, AB, and PVDF was 95:2.5:2.5.

### Evaluation of Nonaqueous Electrolyte Permeability

A 3 μL droplet of propylene carbonate was placed on the top of the positive electrode for each of the above-mentioned Examples 1 to 6 and Comparative Example 1. The time it took for the droplet to disappear was measured as its permeation time. The results are shown in Table 1 below.

TABLE 1

| | Positive electrode | Adding amount | Permeation time |
|---|---|---|---|
| | additive | (% by mass) | (second) |
| Example 1 | Succinic anhydride | 0.1 | 67 |
| Example 2 | Succinic anhydride | 0.5 | 49 |
| Example 3 | Succinic anhydride | 1 | 48 |
| Example 4 | Succinic anhydride | 2 | 47 |
| Example 5 | Maleic anhydride | 0.5 | 46 |
| Example 6 | Phthalic anhydride | 0.5 | 48 |
| Comparative | None | 0 | 98 |
| Example 1 | | | |

Table 1 indicates that in Examples 1 to 6 in which acid anhydride was added to the positive electrode active material layer, the permeation time is shorter than in Comparative Example 1 in which acid anhydride was not added to the positive electrode active material layer. This result reveals that nonaqueous electrolyte permeability can be improved by adding acid anhydride to the positive electrode active material layer. In addition, among Examples 1 to 4 in which succinic anhydride was added, Examples 2 to 4 show a particularly short permeation time.

Next, three droplets composed of a mixed solution of propylene carbonate and succinic anhydride was placed on top of the positive electrode surface of Comparative Example 1 (in which an acid anhydride was not used in the positive electrode active material layer). And the time it took for each droplet of mixed solution to disappear (permeation time) was measured and shown in Table 2. The droplets used contained the additive amount of succinic anhydride to propylene carbonate of 0% by mass, 1% by mass, and 10% by mass.

TABLE 2

| | Amount of succinic acid | |
|---|---|---|
| | added to electrolyte | Permeation time |
| | (% by mass) | (second) |
| Comparative | 0 | 98 |
| Example 1 | 1 | 100 |
| | 10 | 119 |

Table 2 indicates that the permeation time is increased by adding succinic anhydride to the nonaqueous electrolyte. This result reveals that nonaqueous electrolyte permeability cannot be improved even by adding succinic anhydride to the nonaqueous electrolyte, and thus it is necessary to add acid anhydride to the positive electrode active material layer in order to improve nonaqueous electrolyte permeability.

### Evaluation of Output Characteristics

The nonaqueous electrolyte secondary battery formed in each of Example 1 and Comparative Example 1 was subjected to constant-current charge to a battery voltage of 4.4 V at a current of 1 It (750 mA) and then subjected to charge to a current of 1/20 It (37.5 mA) at a constant voltage of 4.4 V. Next, constant-current discharge to a battery voltage of 2.75 V was performed at a current of 3 It (2250 mA). The results are shown in Table 3 below.

TABLE 3

| | Positive | Adding | Discharge |
|---|---|---|---|
| | electrode | amount | capacity |
| | additive | (% by mass) | (mAh) |
| Example 1 | Succinic | 0.1 | 671 |
| | anhydride | | |
| Comparative | None | 0 | 587.5 |
| Example 1 | | | |

Table 3 indicates that the discharge capacity is increased by adding succinic anhydride to the positive electrode active material layer.

### Evaluation of Adhesion

The adhesive strength between the positive electrode active material layer and the positive electrode current collector was evaluated by a 90-degree peeling test method for the positive electrode formed in each of Examples 1 to 6. Specifically, the positive electrode was attached to an acryl plate with a size of 120 mm×30 mm using a double-sided tape (“NICETACK NW-20” manufactured by Nichiban Co., Ltd.) with a size of 70 mm×20 mm. Next, an end of the positive electrode attached was pulled upwardly by 55 mm at a constant rate (50 mm/min) in a direction at 90 degrees with the surface of the positive electrode active material layer using a small desktop tester (“FGS-TV” and “FGP-5”) manufactured by NIDEC Shimpo Corporation to measure peel strength. The results are shown in Table 4 below. The results shown in Table 4 are values normalized by the peel strength of 100 of Example 1.

TABLE 4

| | Positive electrode | Adding amount | Adhesion |
|---|---|---|---|
| | additive | (% by mass) | (%) |
| Example 1 | Succinic anhydride | 0.1 | 100 |
| Example 2 | Succinic anhydride | 0.5 | 87.3 |
| Example 3 | Succinic anhydride | 1 | 51.9 |
| Example 4 | Succinic anhydride | 2 | 25.3 |
| Example 5 | Maleic anhydride | 0.5 | 55.7 |
| Example 6 | Phthalic anhydride | 0.5 | 54.4 |

Table 4 indicates that adhesion tends to be decreased by increasing the amount of succinic anhydride added. The results shown in Table 4 and Table 1 reveal that the amount of acid anhydride added is preferably in the range of 0.1% by mass to 2.0% by mass, and more preferably in the range of 0.5% by mass to 1.0% by mass, based on the positive electrode active material.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A positive electrode for a nonaqueous electrolyte secondary battery comprising:
a positive electrode current collector; and
a positive electrode active material layer formed on the positive electrode current collector,
wherein the positive electrode active material layer comprises a positive electrode active material, a binder, and an acid anhydride.

2. The positive electrode for a nonaqueous electrolyte secondary battery according to claim 1, wherein the acid anhydride is at least one of succinic anhydride, maleic anhydride, and phthalic anhydride.

3. The positive electrode for a nonaqueous electrolyte secondary battery according to claim 1, wherein the content of the acid anhydride relative to the positive electrode active material is within the range of 0.1% by mass to 2% by mass.

4. A nonaqueous electrolyte secondary battery comprising:
an electrode body comprising the positive electrode for a nonaqueous electrolyte secondary battery according to claim 1, a negative electrode, and a separator disposed between the positive electrode and the negative electrode; and
a nonaqueous electrolyte impregnated in the electrode body.

5. A nonaqueous electrolyte secondary battery comprising:
an electrode body comprising the positive electrode for a nonaqueous electrolyte secondary battery according to claim 2, a negative electrode, and a separator disposed between the positive electrode and the negative electrode; and
a nonaqueous electrolyte impregnated in the electrode body.

6. A nonaqueous electrolyte secondary battery comprising:
an electrode body comprising the positive electrode for a nonaqueous electrolyte secondary battery according to claim 3, a negative electrode, and a separator disposed between the positive electrode and the negative electrode; and
a nonaqueous electrolyte impregnated in the electrode body.

7. A method for producing the nonaqueous electrolyte secondary battery according to claim 4, the method comprising:
forming the electrode body; and
impregnating the electrode body with the nonaqueous electrolyte.

8. A method for producing the nonaqueous electrolyte secondary battery according to claim 5, the method comprising:
forming the electrode body; and
impregnating the electrode body with the nonaqueous electrolyte.

9. A method for producing the nonaqueous electrolyte secondary battery according to claim 6, the method comprising:
forming the electrode body; and
impregnating the electrode body with the nonaqueous electrolyte.
